(19) United States
(12) Patent Application Publication
(10) Pub. No.: US 2019/0211930 A1
(43) Pub. Date: Jul. 11, 2019

(54) FLAT GASKET

(71) Applicant: REINZ-DICHTUNGS-GMBH, NEU-ULM (DE)

(72) Inventors: MATTHIAS PENDZIALEK, ULM (DE); MARIUS WINTER, BLAUSTEIN (DE)

(21) Appl. No.: 16/311,939

(22) PCT Filed: Jun. 29, 2017
(86) PCT No.: PCT/EP2017/066098

§ 371 Date: Dec. 20, 2018

(30) Foreign Application Priority Data
Jun. 29, 2016 (EP) PCT/EP2016/065177
Jun. 29, 2016 (EP) PCT/EP2016/065183
Dec. 22, 2016 (DE) 20 2016 107 291.3

(51) Int. Cl. F16J 15/08

(52) U.S. Cl. CPC F16J 15/0825; F16J 15/064

(57) ABSTRACT

A flat gasket may have a carrier layer and at least one first sealing layer, where a through-opening for a fluid passes through the flat gasket and all the layers thereof. At least one spring element having a spring plate and a retaining region for the spring plate may be provided. The retaining region may be connected to the spring plate and surrounding the latter at least in some regions. The spring element may be part of the first sealing layer, or the spring element is arranged, in projection onto the layer plane of the carrier layer, at least in some regions or entirely in the through-opening through the flat gasket, including in the throughflow opening through the carrier layer. It may be connected to the first sealing layer at least in some regions in a form-fitting and/or materially bonded manner.

The present invention relates to a flat gasket, as used for example as a transmission control plate, as a cylinder head gasket, as a gasket for an oil cooler or some other engine gasket or the like. The present invention thus also relates to transmission control plates, cylinder head gaskets and gaskets for oil coolers, which are configured in the manner of the flat gasket according to the invention.

Such flat gaskets often have a carrier layer and at least one sealing layer. One or more throughflow openings for fluids, for example through-openings for control fluids, combustion chamber openings or other through-openings for gases, extend through the flat gasket perpendicular to the layer plane thereof. Other possible openings are through-openings for fastening elements or oil bores or coolant bores.

In particular, transmission control devices usually have two oppositely arranged counterpart components, such as control boxes for example, and also a flat transmission control plate which is arranged between the two counterpart components. This transmission control plate has, on the one hand, the task of sealing the intermediate space between the two counterpart components or the channel sections and bores thereof, in the form of a flat gasket, and, on the other hand, the task of providing through-openings between channels or bores in the opposite counterpart components, the fluid in the channels controlling the function of a transmission. The sealing function is usually realized by embossed beads and/or partial coatings. Transmission control plates thus have throughflow openings for a fluid, via which the fluid can flow from one side of the transmission control plate to the other side of the transmission control plate. Such throughflow openings may contain additional functional elements, for example valve elements which block the flow in one direction or else combined valve/shutter elements which limit the flow in one or both directions.

For example, DE 20 2012 009 539 U1 discloses a transmission control plate in which a movable valve element is arranged within a throughflow opening in the transmission control plate. The mounting of such functional elements usually takes place by additional measures and is complicated and costly.

Proceeding from this prior art, it is therefore an object of the present invention to provide flat gaskets, in particular transmission control plates, cylinder head gaskets, other static gaskets in an internal combustion engine and/or the exhaust tract thereof and other gaskets, in which valves or valve/shutter combinations can be realized in a simple, inexpensive and reliable manner. It is also an object of the present invention to provide transmission control devices using the flat gasket according to the invention. Advantageous developments of the flat gasket according to the invention are given in the dependent claims.

The flat gasket according to the invention has a carrier layer and at least one first sealing layer. Here, the term sealing layer denotes a layer which serves for sealing regions between the carrier layer, adjacent layers and/or adjacent components. For example, a sealing layer may have sealing elements on the side facing towards or away from the carrier layer, for example elastomeric coatings and/or embossed elements, such as sealing beads for example.

The flat gasket additionally has a throughflow opening for a fluid, said throughflow opening passing through the flat gasket and all the layers thereof. Such throughflow openings may be, for example, through-openings for control fluids, such as hydraulic oil for example, through-openings for fastening elements such as screws or rivets, through-openings for cooling fluid, through-openings for engine oil, combustion chamber openings or also other through-openings for gases. Such through-openings are preferably surrounded in the layer plane by sealing elements which are part of the first sealing layer. The latter then serve to seal the through-opening in the layer plane with respect to the adjacent areas in the layer plane.

According to the invention, the flat gasket now has a spring element. Such a spring element has a spring plate and a retaining region for the spring plate, said retaining region being connected to the spring plate and surrounding the latter at least in some regions.

Such a spring element may for example perform a valve or shutter function within the throughflow opening. To this end, the spring plate may be configured as a shutter or also as a valve plate/valve closure. As a result, on the one hand the flows of the fluid through the throughflow opening can be limited or else a one-way valve can be realized within the throughflow opening.

It is advantageous that the spring element in a first variant of the invention is part of the first sealing layer, so that the aforementioned additional functions in the throughflow opening can be realized without any additional component. In addition, the space requirement is reduced, so that overall a cost-effective integration of additional functions is achieved. In particular, no additional manufacturing or assembly steps are required and no additional components have to be held in stock.

A further advantage is that no additional installation space, either in the thickness direction or in the plane direction of the flat gasket, is required for this additionally realized function. The integration of valve/shutter or choke functions and the like in the flat gasket according to the invention thus takes place solely by an appropriate configuration and structuring of the first sealing layer.

Such a flat gasket can be used both as a transmission control plate and as a cylinder head gasket or also as another flat gasket in internal combustion engines or other components. For instance, it is possible to use the flat gasket according to the invention also in other mechatronic units, both in cast components and in layered components.

In a second variant of the present invention, in which all the abovementioned functions are likewise realized, the spring element is arranged, in projection onto the layer plane of the carrier layer, at least in some regions but in particular entirely in the through-opening through the flat gasket, in particular in the throughflow opening through the carrier layer, and is connected to the first sealing layer at least in some regions in a form-fitting and/or materially bonded manner.

This also makes it possible to avoid having to hold additional components in stock compared with the prior art and in particular makes it possible to keep the manufacturing and assembly costs low.

Such a form-fitting and/or materially bonded connection can be achieved in a particularly simple manner if at least in some regions the outer circumferential edge of the spring element extends beyond the circumferential edge of the first sealing layer around the through-opening, that is to say overlaps therewith. This can take place both between the carrier layer and the first sealing layer and on the side of the first sealing layer facing away from the carrier layer, for example by means of welding or soldering.

In both variants, the flat gasket may be advantageously developed if the spring element is configured as a compression spring. To this end, the spring plate may be pre-shaped with respect to the retaining region such that, in the uninstalled state of the flat gasket, it protrudes beyond the side of the carrier layer facing away from the first sealing layer or rests on a stop element adjacent to the carrier layer. A resting on the stop elements within the carrier layer is also possible. To create a passage through the spring element for the fluid in the event of the spring plate lifting away from the region surrounding the retaining elements or retaining arms, either the regions between the retaining arms may be arranged in a suitable manner or else additional throughflow openings may be provided between the spring plate and the edge regions of the spring element or else in the spring plate. Such throughflow openings may also form a non-closable bypass for the fluid.

In a first variant, the compression spring has only a preloaded deflection of the spring plate on one side of the plane of the first sealing layer or of the outer circumferential edge of the spring element. However, it is also possible that the spring element then has, radial to the outer circumferential edge, a circumferential deflection in a first direction and, within this deflected region, the retaining arms surrounding the spring plate are then pre-shaped, in particular are pre-deformed counter to the first direction.

The deflection of the spring plate may be limited in both directions. Here, an abutment is a sealing element which completely seals the spring plate in the closed state. A stop or stop element is an element which defines and limits the maximum deflection of the spring plate.

The deflection of the spring plate may take place in such a way that it takes place perpendicular to the layer plane of the spring plate. During this, the layer plane of the spring plate advantageously remains parallel to the non-deflected state or parallel to the first sealing layer or the carrier layer. The spring plate is thus advantageously not tilted during the deflection.

There may be provided as the stop for the spring plate either the adjacent components, between which sealing is provided by the flat gasket according to the invention, or else additional layers. Such layers may be formed, for example, adjacent to the first sealing layer and facing away from the carrier layer.

The stop elements for the maximum opening of the spring plate may also be formed directly from parts of the spring element or of the first sealing layer. For example, regions of the material adjacent to the retaining arms may be formed as webs and may be deformed out of the plane such that they protrude in an arc-shaped manner out of the plane of the first sealing layer or of the spring element. It is preferred if the arc-shaped webs are in some sections bent out of the plane of the first sealing layer or of the spring element by more than 90° and also this deflection takes place with a curvature. It is thus possible to achieve the situation whereby the middle sections of the arc-shaped webs run substantially parallel—in actual fact rotated through 180°—to the plane of the first sealing layer or of the spring element and thus form a planar stop.

The carrier layer itself may also have protrusions which form stops for the spring plate. Such protrusions may be formed for example by embossing (in some sections or else completely) the circumferential edge of the carrier layer which runs around the throughflow opening.

To efficiently limit the travel of the stop elements, it is advantageous if the protrusions extend radially into the region in which the spring plate moves.

An abutment preferably has a circumferential edge which is configured as a valve opening around a through-opening and on which the spring plate rests in the rest position. Said circumferential edge may for example be configured for its part as a sealing bead, the bead top of which is directed towards the spring plate. It may for example be provided in a second sealing layer, on the opposite side of the carrier layer to the first sealing layer.

The carrier layer itself may for example also have a circumferential protrusion which forms an abutment for the spring plate. Such a protrusion may be formed for example by embossing (in some sections or else completely) the circumferential edge of the carrier layer which runs around the throughflow opening.

It is particularly advantageous if one or more of the sealing layers are made of or contain spring steel, structural steel or an aluminium alloy. However, the spring element and/or optionally the first sealing layer formed in one piece therewith is formed in particular of spring steel, hard spring steel or structural steel in order to ensure the spring properties of the spring element. The carrier layer may advantageously be made of or contain structural steel and/or an aluminium alloy. Spring steel is also possible, but not common, since carrier layers are usually not profiled and have a large thickness compared to the sealing layers. Structural steel is therefore particularly suitable for carrier layers.

Like the spring elements used, sealing layers have typical thicknesses of 0.1 mm to 0.3 mm (including and/or excluding the boundary values). Carrier layers typically have thicknesses of 0.25 mm to 8 mm (including or excluding the boundary values).

According to the invention, therefore, either a pre-shaped spring element is manufactured as an insert, inserted into the opening of the carrier layer and previously or subsequently connected to the first sealing layer. It is not necessary here for the connection between the spring element and the first sealing layer to be made fluid-tight since, for example, the throughflow opening can be sealed by sealing elements which run around the throughflow opening in the first sealing layer outside of the spring element. Alternatively, the compression spring is formed directly from the first sealing layer (stamped and shaped).

By virtue of a pre-shaped and preloaded spring element in the first sealing layer, which is also spaced apart from a possibly provided second sealing layer by the carrier layer, a defined preloading force of the spring plate can be set. This ensures for example that the spring plate, in so far as the spring element is configured as a valve, opens only with effect from a predefined pressure difference between the two sides of the spring plate and thus with the two sides of the carrier layer or of the flat gasket. As soon as the spring plate lifts away from its seat, fluid can flow from one side of the flat gasket to the other. As the fluid flow increases, the spring plate then lifts further away from its seat and exposes a larger throughflow opening. This is achieved, for example, in that the spring plate is retained by way of spiral retaining arms as the retaining element. As the spring plate is lifted away, the intermediate spaces between the spiral retaining arms close to an increasing extent. To avoid complete closure, a stop may be provided. The spring travel here is preferably more than 0.4 mm.

If the cross-section of said openings is insufficient, further openings may be formed in the spring element.

It is not necessary to provide a stop for a spring element configured as a compression spring. The opening characteristic of the spring element can be configured such that no stop is required. This is possible for example when the spring has a degressive opening characteristic and thus does not have a linear course as in the case of conventional spiral springs, but rather has a non-linear characteristic which rises as the cross-sectional opening increases. If necessary, however, it is also possible to provide a stop which limits the lifting of the spring plate in a direction perpendicular to the layer plane of the first layer.

Some examples of flat gaskets according to the invention will be given below. In each case, a plurality of advantageous features of a flat gasket according to the invention are shown in conjunction with one another. However, said individual optional features may develop the present invention not only jointly but also individually or in combination with other optional features from other examples. Hereinbelow, identical or similar reference signs will be used for identical or similar elements, and therefore the description of said elements will in some cases not be repeated.

In the figures:

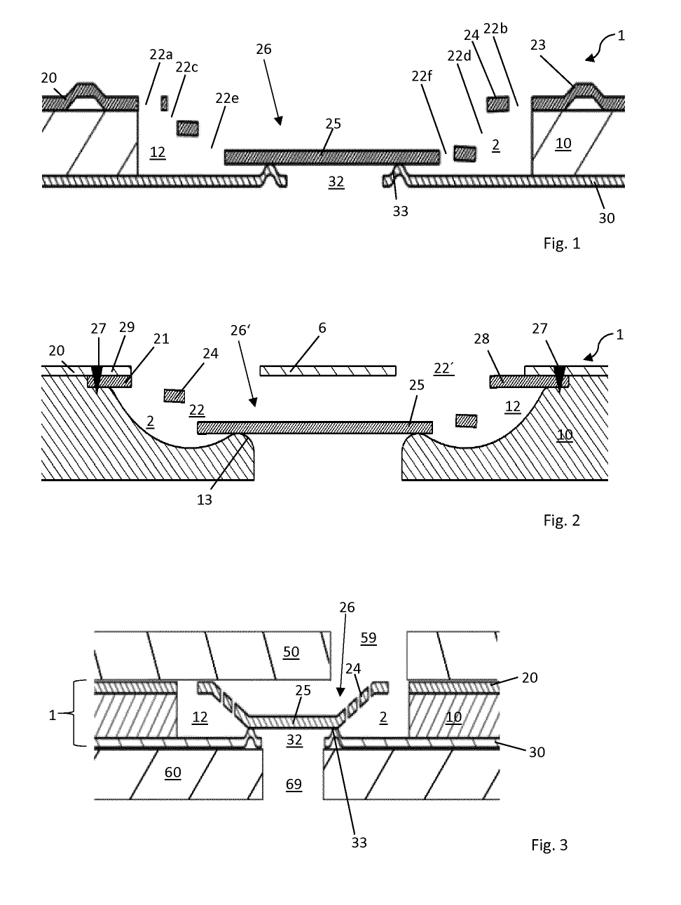

FIGS. 1-2 show details of flat gaskets according to the invention in cross-section;

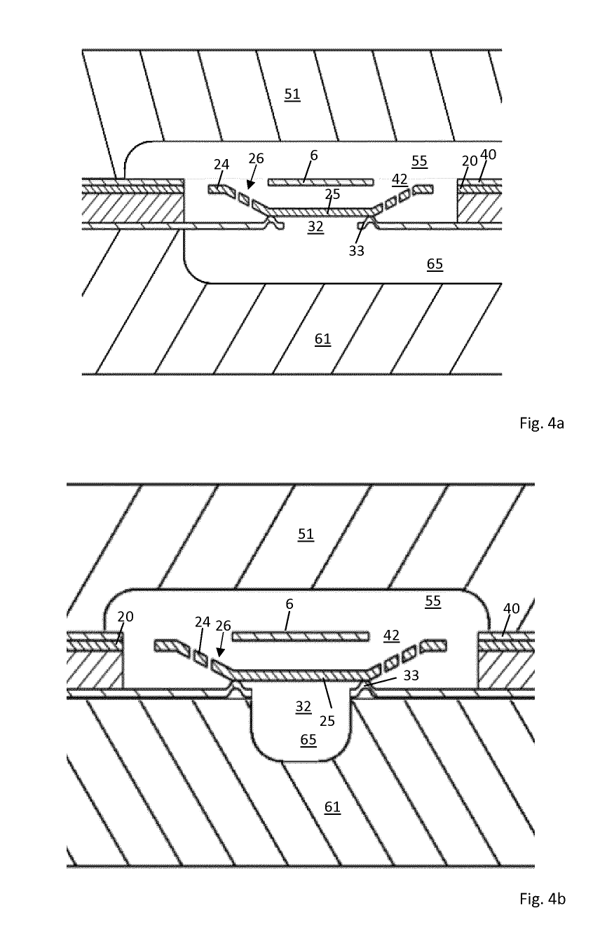

FIGS. 3-4 show details of flat gaskets according to the invention in cross-section, in the installed state;

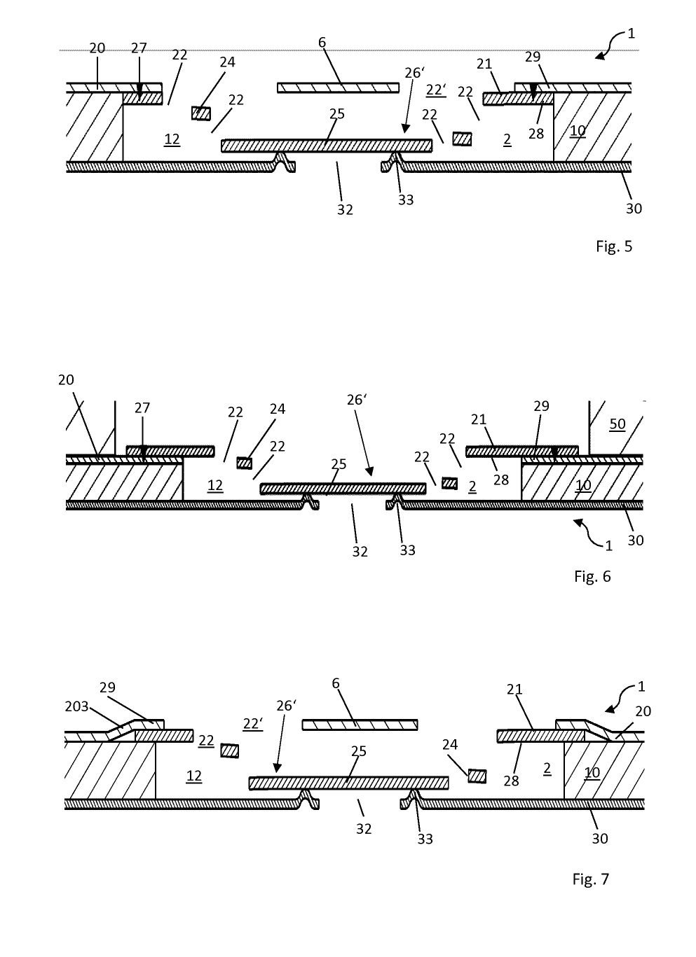

FIGS. 5-16 show details of further flat gaskets according to the invention in cross-section;

FIG. 17 shows, in an oblique view, a spring element with integrated stop elements, as used in flat gaskets according to the invention;

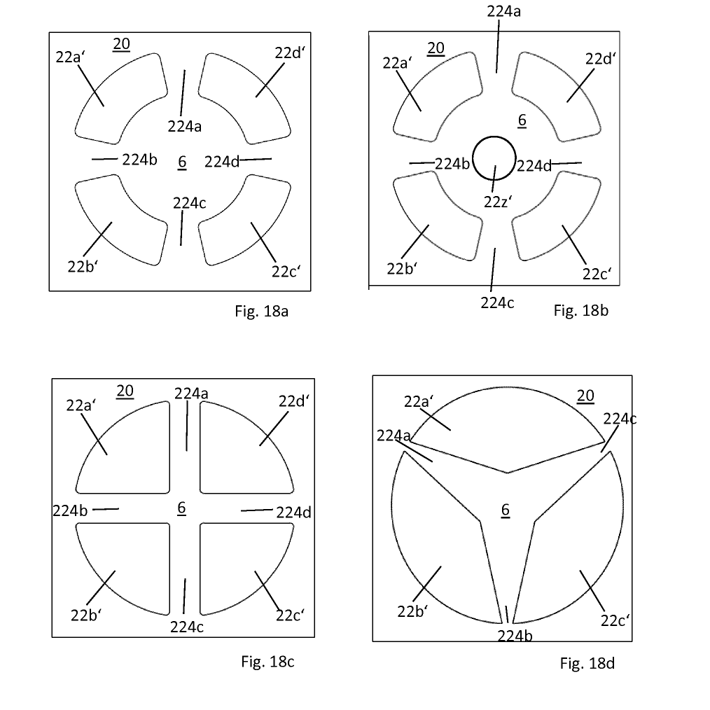

FIG. 18 shows, in plan view, four details of sealing layers of flat gaskets according to the invention, in the region of stop elements; and

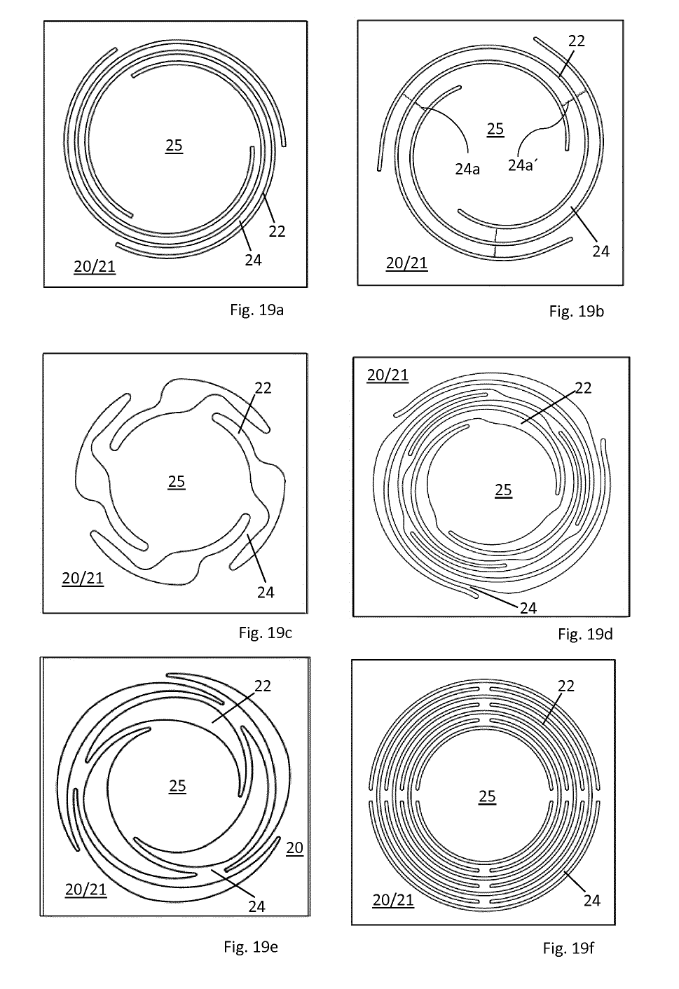

FIG. 19 shows, in plan view, six details of spring elements and/or sealing layers with spring elements of flat gaskets according to the invention.

FIG. 1 shows a detail of a flat gasket 1, for example of a transmission control plate. A detail around a through-opening 2 is shown, said through-opening extending through the entire transmission control plate. The transmission control plate 1 has a carrier layer 10 made of structural steel and, adjacent to the two layer surfaces thereof, a first sealing layer 20 and a second sealing layer 30. Said two sealing layers 20 and 30 each seal laterally in the layer plane around the through-opening 2. The through-opening 2 in the transmission control plate 1 extends through the entire transmission control plate, with its opening sections 32 in the second sealing layer 30, 12 in the carrier layer 10, and 22 in the first sealing layer 20.

The sealing element of the second sealing layer 30 around the through-opening 2 is located outside of the detail shown. The first sealing layer 20 has, running around the through-opening 2, a sealing bead 23 which brings about the above-described sealing around the through-opening 2. In addition, the first sealing layer 20 has a spring element 26 which, as viewed perpendicular to the layer plane, is arranged in the through-opening 2. The spring element 26 has a spring plate 25 and retaining arms 24 of a retaining region. The retaining arms 24 are spiral-shaped. A separate reference sign for the retaining region has been omitted for the sake of clarity; unless indicated otherwise, the retaining region is formed by the retaining arms 24.

The spring plate 25 rests on a bead 33 in the second sealing layer 30, which is configured to run around the throughflow opening 32. Both of these together form a one-way valve. The bead 33 serves on the one hand as an abutment and lift-limiting means for the spring plate 25 and on the other hand for sealing between the second sealing layer 30 and the spring plate 25 in the closed state of the valve. In the state shown, the retaining arms 24 are spread apart and form throughflow openings 22c to 22f for the passage of fluid from one side of the first sealing layer 20 to the other side of the first sealing layer 20. However, said openings are open to a maximum when the spring plate is resting on the abutment 33 and thus the valve is closed.

If the pressure difference between the second side of the transmission control plate on the same side as the second sealing layer 30 and the first side of the transmission control plate 1 on the same side as the first sealing layer 20 increases, then, once the preloading of the spring plate 25 has been overcome, the spring plate 25 lifts away from the bead 33 so that the fluid can flow through the openings 32 and 22a to 22f and thus through the through-opening 2. As it lifts further away, however, the openings 22c-22f close to an increasing extent. Further throughflow openings 22a and 22b are therefore provided adjacent to the retaining arms 24, between the latter and the region of the first sealing layer 20 surrounding the throughflow opening 12, through which further throughflow openings the fluid can flow unhindered even when the valve is open to different extents.

The valve formed by the valve plate 25 and the abutment 33 is shown in the closed normal state in FIG. 1. For this, the spring plate in the spring element 26 is preloaded such that it normally rests on the abutment 33. Only under suitable pressure conditions does the spring plate 25 lifts away from the abutment 33. The valve plate is therefore closed in the absence of a particular higher pressure on the same side as the abutment 33 compared to the pressure on the side of the transmission control plate facing away from the second sealing layer 30. Here and in the subsequent examples, the lifting takes place while maintaining the orientation of the layer plane of the spring plate, that is to say without any tilting of the spring plate.

FIG. 2 shows a transmission control plate which differs in a few design features from that of FIG. 1. First, the spring element 26′ is not manufactured integrally with the first sealing layer, but instead consists of an insert 21 which, in projection onto the layer plane of the carrier layer, is largely arranged, in particular arranged with its spring plate 25, in the throughflow opening 12 through the carrier layer and is connected to the first sealing layer in some regions in a materially bonded manner. To this end, the carrier layer 10 has, on the surface thereof facing towards the first sealing layer 20, a recess which runs around the through-opening and in which the edge region of the insert 21 comes to lie. The first sealing layer 20 is arranged on the insert 21 and on the carrier layer 10 and is spot-welded at least to the insert 21. With the sheet thickness of just 0.15 mm as is the case here both in the case of the first sealing layer 20 and in the case of the insert 21, the welded join may even extend into the carrier layer 10. The side of the carrier layer 10 located opposite to the first sealing layer 20 is deformed such that the throughflow opening 12 in this region has a smaller clear width than the width of the spring plate 25. The circumferential edge 13 of the carrier layer 10, which is formed for example by embossing or other shaping techniques, thus forms an abutment for the valve plate 25, which replaces the abutment 33 in FIG. 1. A second sealing layer can thus be omitted entirely; the sealing on the surface facing away from the first sealing layer 20 can also be brought about for example by means of screen-printed elements (not shown here).

In order that the spring plate 25 does not excessively lift away from the abutment 13, a stop 6 is formed in the first sealing layer 20, said stop being connected to the circumferential edge 29 of the first layer 20 via retaining arms (not shown here). Throughflow openings 22′ remain between said retaining arms. Furthermore, the first sealing layer does not have the additional throughflow openings 22a, 22b shown in FIG. 1. Second, the transmission control plate 1 has no second sealing layer. If necessary, however, these can be added in the insert 21 and/or in the first sealing layer 20.

Hereinafter, reference sign 26 will be used for spring elements which are an integral part of a continuous layer, while reference sign 26′ or 26″ denotes those spring elements which are configured as an insert 21.

FIG. 3 shows a metal flat gasket 1, which is constructed similarly to that in FIG. 1, in the installed state between two counterpart components 50, 60. The counterpart components 50, 60 each have through-openings, often also referred to as bores depending on their shape, 59, 69, which adjoin the through-opening 2 of the flat gasket 1. In the illustrated exemplary embodiment, the through-openings 59, 69 are offset from one another in the layer plane of the carrier layer 10, but they could also be formed substantially in alignment with one another. Fluid, for example coolant, enters the throughflow opening 32 through the through-opening 69 in the counterpart component 60. At a sufficiently high pressure, the spring plate 25 will lift away from its abutment 33 and thus opens the through-opening 2. The coolant flows through between the retaining arms 24 of a retaining region and exits through the through-opening 69 in the counterpart component 69.

FIG. 4 shows, in two views, sections through a hydraulic control module with a transmission control plate 1 installed between a top box 51 and a bottom box 61. The structure of the transmission control plate 1 largely corresponds to that of FIG. 1, but no sealing element is shown in the sealing layer 20 in the detail shown and a further, third, sealing layer 40 is arranged on the surface of the first sealing layer 20 facing away from the carrier layer 10. A stop 6 is formed in this third sealing layer 40, said stop limiting the excessive lifting of the spring plate 25. The stop is spaced apart from the outer regions of the third sealing layer 40 by throughflow openings 42. In the detail shown, the top box 51 and also the bottom box 61 each have a channel 55, 65. It is clear from sub-FIG. 4a that both channels end adjacent to the through-opening 2 and the flow of the transmission control oil conducted in the channels continues from the channel 65 through the through-opening 2 and into the channel 55 when the spring plate 25 is open. Sub-FIG. 4b looks into the channels 55, 65, that is to say from left to right with reference to sub-FIG. 4a. It is clear here that the cross-section of the channels 55, 65 communicating with one another can be very different.

FIG. 5 shows a further transmission control plate 1. However, this is different from the transmission control plate in FIG. 1 since the spring element 26′ is now configured as an individual insert 21, as in FIG. 2, said insert being arranged within the throughflow opening 12 in the carrier layer 10. The spring element 26′ has the spring plate 25 known from FIG. 1 and the retaining arms 24. A flange region 28 is additionally provided adjacent to the retaining arms in the radially outward direction, said flange region being welded at connection points 27 to the first circumferential edge 29 around the throughflow opening 22 of the first sealing layer 20. Both the insert 21 and the first sealing layer 20 are made of hard spring steel, wherein the sealing layer with a sheet thickness of 0.20 mm is slightly smaller than that of the insert with 0.25 mm. It is advantageous here that the first sealing layer can now be connected to the spring element 26′ and thus only a single part has to be held in stock and installed in order to assemble the transmission control plate 1.

Furthermore, the first sealing layer 20 has a stop 6 arranged centrally in the throughflow opening 22. Said stop can be connected to the surrounding region of the first sealing layer 20 for example by retaining arms which are not visible in the illustrated cross-section. Throughflow openings 22′ in the first sealing layer 20 are thereby created. Said stop 6 serves as a lift-limiting means for the spring plate 25 during the opening of the spring plate 25, the latter being preloaded in the direction of the second sealing layer 30.

FIG. 6 shows a further transmission control plate according to the present invention, which is configured similarly to that in FIG. 5. In addition to the transmission control plate 1, a counterpart component 50 is shown. In a manner differing from FIG. 5, the flange region 28 of the spring element 26′ is now configured such that it protrudes beyond the circumferential edge of the throughflow opening 12 and thus overlaps with the circumferential edge 29 around the throughflow opening 22 of the first sealing layer 20. Said flange region 28 is arranged on the side of the first sealing layer 20 facing away from the carrier layer 10 and is soldered to the circumferential edge 29 of the first sealing layer 20. This results in a seal between the spring element 26′ and the first sealing layer. It is possible that the sealing layers 10, 20, 30 are first connected to one another (not shown) and the spring element 26′ can then be placed on and soldered to the first sealing layer 20. Installation of the insert 21 is thus particularly easy.

In principle, however, it is not necessary for the connection point 27 to seal completely all the way around the through-opening 2. Connections only at points or in some sections, for example in circumferential lines or also in radially extending lines, can also be used.

FIG. 7 shows a further transmission control plate similar to that in FIG. 1. In a manner differing from FIG. 1, however, the circumferential edge 29 of the first sealing layer 20 is now pulled forward into the passage 12 through the carrier layer 10, so that it overlaps with the circumferential flange 28 of the spring element 26′ and is connected to the latter in a form-fitting manner at a connection point 27. In FIG. 7, the flange 28 is arranged on the side of the first sealing layer 20 facing towards the carrier layer. In addition, a lift-limiting element 6 similar to that in FIG. 5 is provided. Once again, throughflow openings 22′ are created in the plane of the lift-limiting element 6, said throughflow openings being formed in addition to the throughflow openings 22 between the retaining arms 24 of a retaining region of the spring element 26′.

In the arrangement in FIG. 7, the spring element 26′ may have an external diameter which is smaller than the clear width of the opening 12. In this case, the spring element 26′ is then arranged entirely in the throughflow opening 12 through the carrier layer 10 in the transmission control plate 1. Alternatively, as shown in FIG. 7, the flange 28 may also have an external diameter which is larger than the clear width of the passage 12 (at least in some sections around the circumferential edge of the throughflow opening 12), so that the flange 28 extends beyond the circumferential edge of the carrier layer 10 around the throughflow opening 12. The flange 28 transitions into the retaining arms 24, which are shown in section in different regions on the right-hand and left-hand side of the through-opening 2. In this case, the first sealing layer has an angled portion 203 arranged in the region of the outer edge of the flange 28, with which the circumferential edge 29 is offset from the carrier layer 10 in relation to the adjacent region of the first sealing layer 20.

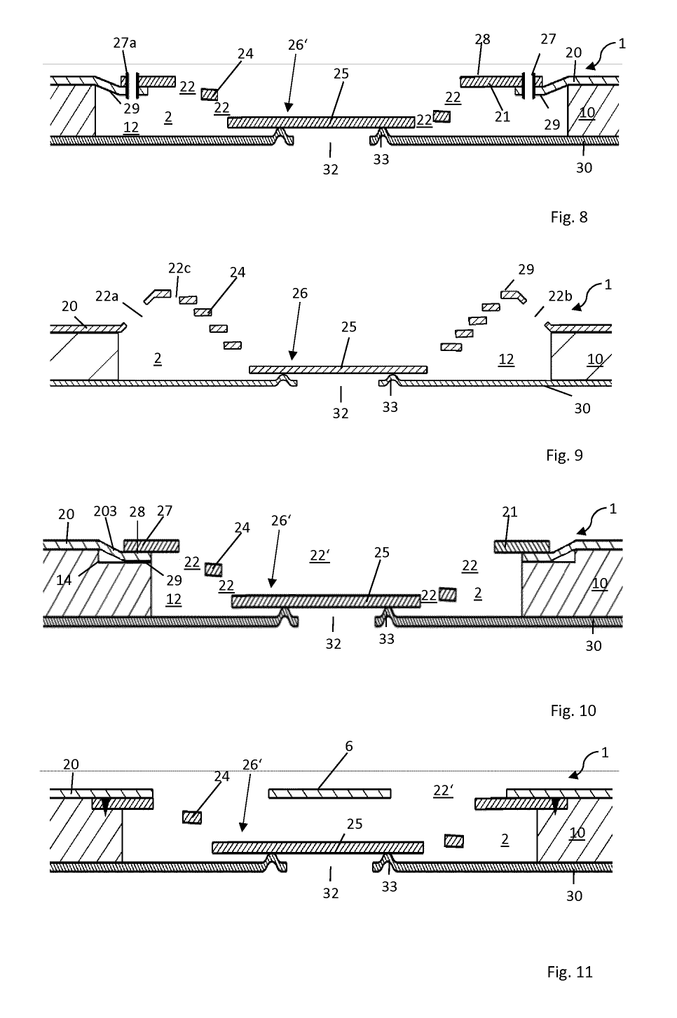

FIG. 8 shows a further transmission control plate 1 according to the present invention, which is similar to that in FIG. 7. In a manner differing from the transmission control plate in FIG. 7, however, the flange 28 is now arranged on the side of the sealing layer 20 facing away from the carrier layer 10. However, the angled portion between the circumferential edge 29 and the adjacent region of the first sealing layer 20 is now directed in the other direction. Here, however, the insert 21 is connected to the first sealing layer 20 via a plurality of rivets 27a.

FIG. 9 shows a further embodiment of a transmission control plate according to the invention, similar to that in FIG. 1. In a manner differing from FIG. 1, the first sealing layer 20 now has, between the circumferential edge 29 and the adjacent regions of the first sealing layer 20, a circumferential deflection in the manner of a plastically deformed half-bead 203, similar to the angled portion in FIG. 7. This deformation is located outside of or at the outer edge of the retaining region, that is to say radially outside of the region in which the retaining arms 24 extend. However, since the spring element 26 is integrally formed with the first sealing layer 20, this angled portion increases the lift of the spring plate 25 and thus changes the opening and closing characteristic of the spring plate 25. The passage openings 22a and 22b, which are also provided in FIG. 1, are arranged in the angled region.

The detail shown in FIG. 9 does not have in the first sealing layer any special, additional sealing bead (sealing bead 23 in FIG. 1) running around the through-opening 2.

FIG. 10 shows a further embodiment of a transmission control plate according to the invention, similar to that in FIG. 8. In a manner differing from FIG. 8, however, the flange region 28 now extends beyond the circumferential edge of the carrier layer 10. In the region in which the circumferential edge 28 overlaps with the carrier layer 10, the carrier layer 10 has a cutout/step 14, in which the angled region 29 of the first sealing layer 20 is arranged. In this way, it is possible to arrange the flange region 28 in the layer plane of the first sealing layer 20—outside of the angled region 29—and thus to avoid any thickening of the transmission control plate 1. The throughflow openings 22 again run between the retaining arms 24 of the spring element 26′. The throughflow opening 22′ is the section of the through-opening 2 which passes through the first sealing layer 20. It is clear here that the throughflow openings 22 and 22′ overlap in some sections, namely in the region in which a cutout runs between the retaining arms 24 in the plane of the first sealing layer 20.

The embodiment of FIG. 11 is based on the embodiment of FIG. 5, but the insert 21 here is not directly connected to the first sealing layer 20 but rather lies in a recess of the carrier layer 10, which is formed around the throughflow opening 22 on the surface of the carrier layer 10 pointing away from the second sealing layer 30, and is welded to the carrier layer 10 in said recess.

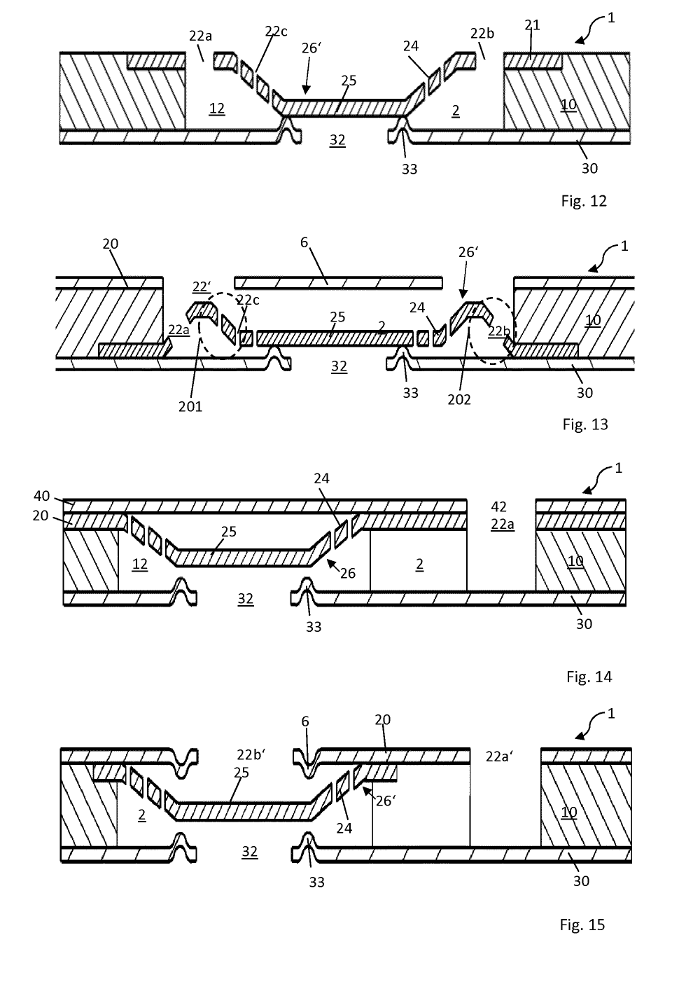

FIG. 12 illustrates a particularly simple embodiment of a metal flat gasket 1, in which a spring element 26′ configured as an insert 21 is inserted in a recess that runs around the through-opening 2 in the surface of the carrier layer 10. A first sealing layer 20 is not present in this exemplary embodiment, but a second sealing layer 30 is present, which once again forms a bead 33 as an abutment for the spring plate 25.

FIG. 13 shows an embodiment of a metal transmission control plate 1, in which the spring element 26′ is not only preloaded against the bead-shaped abutment 33 in its region 201 adjacent to the spring plate 25 by a plastic deformation of the retaining arms 24, but rather the spring element 26′ also has a circumferential deflection in its region 202 spaced apart from the spring plate 25 by the region 201. Said deflection makes it possible for the spring element 26′ to be arranged in a circumferential recess on the surface of the carrier layer 10 facing towards the first sealing layer and to rest on the abutment 33 of the second sealing layer 30 in the closed state on this surface of the carrier layer 10.

In the region of said deflection, two throughflow openings 22a, 22b are present in the illustrated cross-section, which, in addition to the throughflow openings between the retaining arms 24, of which only one is explicitly designated 22c, enables in the open state of the valve a flow of hydraulic control fluid from the throughflow opening 32 of the second sealing layer 30 to the throughflow opening 22′ of the first sealing layer 20.

In the embodiment of FIG. 14, the throughflow openings 22a, 42 of the first and third sealing layers 20, 40 are shifted parallel to the plane of the layers relative to the throughflow opening 32 of the second sealing layer 30. As a result, the through-opening 2 has an overall angled course.

The embodiment of FIG. 15 also has a throughflow opening 22a′ in the first sealing layer which is shifted parallel to the plane of the layers relative to the throughflow opening 32 of the second sealing layer 30. However, it also has a further throughflow opening 22b′ in the first sealing layer 20, which is arranged in the axial extension of the throughflow opening 32. A switching valve is thus formed. In the state shown, the spring plate is lifted slightly away from the abutment 33, so that fluid can flow from the throughflow opening 32 both in the direction of the throughflow opening 22a′ and also through the intermediate spaces 22 between the retaining arms 24 in the direction of the throughflow opening 22b′. On the other hand, when the spring plate 25 rests on the abutment 33, only one flow to the throughflow opening 22b′ is possible. If the spring plate is lifted so far away that it bears against the stop 6, then only a flow in the direction of the throughflow opening 22a′ is possible.

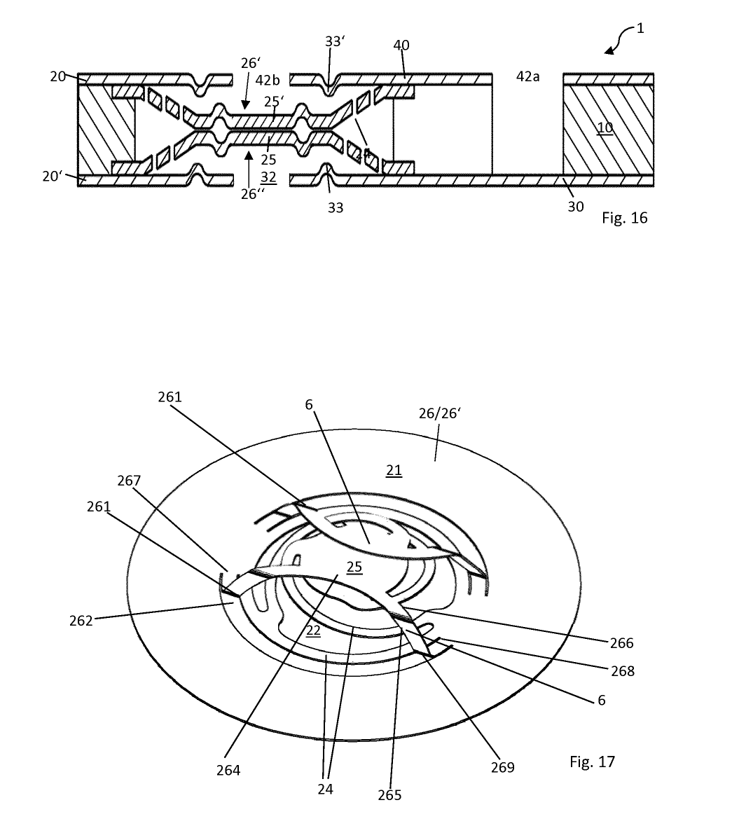

FIG. 16 further develops this embodiment in that two first sealing layers 20, 20′ are arranged substantially mirror-symmetrical to one another, between which there is a carrier layer in which both cutouts are formed, a spring element 26″, 26′ having a spring plate 25, 25′ being received in each cutout. This enables in particular the use of two spring elements 26′, 26″ with different spring characteristics, so that the flow in the direction of the throughflow openings 22a′ and 22b′ can be precisely adapted.

FIG. 17 shows an oblique view of a spring element 26/26′, which is either integrated as an insert 21 in a sealing layer or is an integral part of a sealing layer 20, wherein, in the latter case, only a partial representation is shown. This spring element 26/26′ is characterized in that arc-shaped stop elements 6 are formed from the sheet material of the spring element 26, 26′ from the immediate vicinity of the retaining arms 24 and at only a slight distance from said retaining arms 24. Said stop elements are cut free at their two longitudinal edges 265, 266, but are still connected to the sheet metal layer at their two short edges 267, 268. At the two edges 261, 269, they are bent out of the plane of the sheet metal layer and bend further in their further course, so that the middle region 264 thereof is rotated through approximately 180′ in comparison to the course of the sheet metal strip in the region of the connecting edge 261 and thus forms a flat abutment as a stop 6 (lift-limiting means) for the spring plate 25.

FIG. 18 shows details of different embodiments for a sealing layer, for example sealing layer 20 in FIG. 11, with stop elements 6.

In FIG. 18a, a stop element 6 is integrally connected to a retaining region of the sealing layer 20 via retaining arms 224a to 224d. The retaining arms are arranged in each case in a manner offset by 90° to one another. They leave a total of four throughflow regions 22a′ to 22d′ therebetween.

FIG. 18b shows a modification of the arrangement of FIG. 18a. The travel-limiting element 6 has in the centre an additional throughflow opening 22z′, which can be closed by a spring plate bearing against it.

FIG. 18c shows a further similar travel-limiting element, which has through two intersecting webs consisting of partial arms 224b and 224d, and 224a and 224c. Said webs meet in the middle and form the travel-limiting element 6.

FIG. 18d shows a modification of the embodiment of FIG. 18c. It is now not four arms that are used, which together form two webs spanning the through-opening, but rather just three arms 224a to 224c, which meet in the middle of the through-opening and thus form a star-shaped travel-limiting element 6.

FIGS. 19a to 19f show different embodiments in respect of the first sealing layer 20 with spring element 26, or an insert 21 with spring element 26′. The individual embodiments in FIGS. 19a to 19f differ essentially by the design of the retaining arms 24 of the retaining region of the spring element. In FIG. 19a, these are arranged concentrically in a spiral shape. In FIG. 19b, the retaining arms 24 are likewise arranged concentrically in a spiral shape, but are wider than the retaining arms 24 in FIG. 19a and also have kinks or other pre-deformations 24a, 24a′ which influence the spring behaviour and thus the opening behaviour of the spring plate 25. FIG. 19c shows concentric retaining arms, wherein in each case successive retaining arms 24 are connected to one another at two opposite points. For connection points arranged successively in the radial direction, the connection points are in each case offset by 90° to one another.

FIG. 19d likewise shows retaining arms 24 which run concentrically, said retaining arms having a particular shape so that the fluid throughflow area remaining between the retaining arms 24 is sufficiently large.

FIG. 19e shows retaining arms 24 similar to those in FIG. 19d, but the number thereof is greater and in addition the retaining arms are branched.

FIG. 19f also shows concentric, branched retaining arms 24, which in each case leave sickle-shaped throughflow regions 22 therebetween for the fluid.

1-18. (canceled)

19. A flat gasket comprising a carrier layer and at least one first sealing layer, at least one through-opening for a fluid, said through-opening passing through the flat gasket and all the layers thereof, and at least one spring element having a spring plate and a retaining region for the spring plate, said retaining region being connected to the spring plate and surrounding the latter at least in some regions,
wherein the spring element is part of the first sealing layer, or the spring element is arranged, in projection onto the layer plane of the carrier layer, at least in some regions or entirely in the through-opening through the flat gasket, in the throughflow opening through the carrier layer, and is connected to the first sealing layer at least in some regions in a form-fitting and/or materially bonded manner.

20. The flat gasket according to claim 19, wherein at least in some regions an outer circumferential edge of the spring element extends beyond the circumferential edge of the first sealing layer around the through-opening, between the first sealing layer and the carrier layer or on the side of the first sealing layer facing away from the carrier layer, and in the overlap region is connected to the sealing layer in a form-fitting and/or materially bonded manner.

21. The flat gasket according to claim 19, wherein the spring plate is pre-shaped with respect to the retaining region such that, in the uninstalled state of the flat gasket, it does not protrude beyond the carrier layer on the side of the carrier layer facing away from the first sealing layer or, in the installed state, rests in the rest position on a further layer of the flat gasket, said further layer being arranged on the side of the carrier layer facing away from the first sealing layer, on at least one protrusion in a circumferential edge of the carrier layer in the through-opening, or on a counterpart component.

22. The flat gasket according to claim 19, wherein a second sealing layer is arranged on the opposite side of the carrier layer to the first sealing layer.

23. The flat gasket according to claim 22, wherein the edge of the second sealing layer running around the throughflow opening forms an abutment for the spring plate.

24. The flat gasket according to claim 23, wherein the abutment is configured as a bead, the bead top of which is directed towards the spring plate.

25. The flat gasket according to claim 22, wherein the second sealing layer has at least one sealing element, comprising an embossed sealing element, comprising a sealing bead, which runs all the way around the throughflow opening.

26. The flat gasket according to claim 19, wherein the first sealing layer has at least one sealing element, comprising an embossed sealing element, comprising a sealing bead, which runs all the way around the throughflow opening.

27. The flat gasket according to claim 19, wherein the first sealing layer has at least one stop element for the spring plate.

28. The flat gasket according to claim 19, wherein the carrier layer has in the through-opening, at least in some regions along a circumferential edge of the through-opening, a protrusion which forms an abutment for the spring plate.

29. The flat gasket according to claim 19, wherein some or all sealing layers are made of or contain spring steel, structural steel or an aluminium alloy.

30. The flat gasket according to claim 19, wherein the carrier layer is made of or contains structural steel or an aluminium alloy.

31. The flat gasket according to claim 19, wherein one, some or all sealing layers have, in unembossed regions, a thickness DD where 0.1 mm≤DD≤0.3 mm.

32. The flat gasket according to claim 19, wherein the carrier layer has a thickness DT where 0.25 mm≤DT≤8 mm.

33. The flat gasket according to claim 19, wherein the spring plate, in the force-free state, is spaced apart from the retaining region by ≤0.4 mm perpendicular to the areal extent of said spring plate.

34. The flat gasket according to claim 19, wherein a region of the spring element outside of or at the outer edge of the retaining region has a circumferential section in which the spring element is deflected in the manner of a plastically deformed half-bead.
